(19) United States
(12) Patent Application Publication
(10) Pub. No.: US 2014/0063419 A1
(43) Pub. Date: Mar. 6, 2014

(54) Display Panel and Liquid Crystal Display Device

(71) Applicant: Shih-Hsun Lo, Shenzhen (CN)

(72) Inventor: Shih-Hsun Lo, Shenzhen (CN)

(73) Assignee: SHENZHEN CHINA STAR OPTOELECTRONICS TECHNOLOGY CO. LTD., Shenzhen (CN)

(21) Appl. No.: 13/640,993

(22) PCT Filed: Sep. 10, 2012
(86) PCT No.: PCT/CN12/81165

§ 371 Date: Oct. 12, 2012

(30) Foreign Application Priority Data
Sep. 4, 2012 (CN) 201210323553.1

(51) Int. Cl. G02F 1/1335; G02F 1/1343

(52) U.S. Cl. 349/106

(57) ABSTRACT

The present invention provides a display panel, which comprises an array substrate and a color filter substrate set opposite to each other and a liquid crystal layer set in between. The array substrate has a shield electrode. The color filter substrate has a common electrode. The common electrode and the shield electrode are equipotential so that the liquid crystal layer between the common electrode and the shield electrode forms normally black display. The present invention adds a shield electrode on the array substrate. The shield electrode and the common electrode on the color filter substrate are equipotential, which allows the liquid crystal layer set in between forming normally black display that substitutes BM layer to achieve the shielding effect and improves the opening ratio of the display panel.

### BACKGROUND OF THE INVENTION

1. Field of the Invention

The present invention relates to the field of displaying techniques, and in particular to a display panel and a liquid crystal display device.

2. The Related Arts

The known liquid crystal display device comprises an array substrate, a color filter substrate and a liquid crystal layer set in between. FIG. 1 is a schematic view illustrating the structure of a known display panel. FIG. 2 is a schematic view illustrating the partial structure of a pixel region of the display panel shown in FIG. 1. FIG. 3 is a schematic view illustrating cross-sectional structure of FIG. 2 taken along the line AA. Referring to FIG. 1, FIG. 2 and FIG. 3, it shows the display panel 100 comprises a array substrate 110, a color filter substrate 120 and a liquid crystal layer 130 set in between. The array substrate 110 comprises a scanning electrode 111, a data electrode 112 and a rectangular pixel region 113 formed by crossing each other. Each pixel region 113 further comprises a pixel electrode 114 and a thin film transistor (TFT) 115 used to drive the pixel electrode 114. The pixel electrode 114 electrically connects with the source of the TFT 115 through a contact hole 116. In order to block the disordered liquid crystal caused by the fringe field of the pixel electrode 114 and the light leak region at the edge from the data electrode 112 to the pixel electrode 114, there is a black matrix (BM) layer 117 set opposite to the color filter substrate 120.

Counting out the opaque region blocked by the black matrix layer 117, the transparent region of each pixel region 113, namely, is the opening ratio of the display panel 100. The larger opening ratio allows better light transmittance and better energy performance of the display panel 100.

Thus, it is desired to provide a display panel and a liquid crystal display device that increases the opening ratio of the display panel enormously.

### SUMMARY OF THE INVENTION

The technical issue to be addressed by the present invention is to provide a display panel and a liquid crystal display device, which can increase the opening ratio of the display panel enormously.

To achieve the above technical issue, the present invention provides a display panel, which comprises an array substrate and a color filter substrate set opposite to each other and a liquid crystal layer set in between, the array substrate has a shield electrode, the color filter substrate has a common electrode, the common electrode and the shield electrode are equipotential so that the liquid crystal layer between the common electrode and the shield electrode forms normally black display, the array substrate further comprises a data electrode and a scanning electrode set perpendicular to each other, and a pixel electrode set in the area surrounded by the data electrode and the scanning electrode, the shield electrode is set below the pixel electrode, and the shield electrode is transparent electrode layer or opaque metal layer set parallel to the scanning electrode.

According to a preferred embodiment of the present invention, the scanning electrode is set on the surface of the array substrate, an insulation layer, the shield electrode, a passivation layer and the pixel electrode set on the scanning electrode sequentially, the shield electrode is an entirely transparent electrode layer covered on the insulation layer.

According to a preferred embodiment of the present invention, the scanning electrode is set on the surface of the array substrate, the insulation layer, the shield electrode, the passivation layer and the pixel electrode set on the scanning electrode sequentially, wherein the shield electrode is a bar-like electrode set above the scanning electrode and parallel to the data electrode, the width of the shield electrode is larger than that of the scanning electrode, the shield electrode at least extends to the edge of the adjacent two pixel electrodes located at the both sides of the scanning electrode.

According to a preferred embodiment of the present invention, the data electrode is set on the surface of the array substrate, the insulation layer, the shield electrode, the passivation layer and the pixel electrode set on the data electrode sequentially, wherein the shield electrode is a bar-like electrode set above the data electrode and parallel to the scanning electrode, the width of the shield electrode is larger than that of the data electrode, the shield electrode at least extends to the edge of the adjacent two pixel electrodes located at the both sides of the data electrode.

To achieve the above technical issue, the present invention provides a display panel, which comprises an array substrate and a color filter substrate set opposite to each other and a liquid crystal layer set in between, the array substrate has a shield electrode, the color filter substrate has a common electrode, the common electrode and the shield electrode are equipotential so that the liquid crystal layer between the common electrode and the shield electrode forms normally black display.

According to a preferred embodiment of the present invention, the array substrate comprises a data electrode and a scanning electrode set perpendicular to each other, and a pixel electrode set in the area surrounded by the data electrode and the scanning electrode, wherein the shield electrode is set below the pixel electrode.

According to a preferred embodiment of the present invention, the scanning electrode is set on the surface of the array substrate, an insulation layer, the shield electrode, a passivation layer and the pixel electrode set on the scanning electrode sequentially, wherein the shield electrode is an entirely transparent electrode layer covered on the insulation layer.

According to a preferred embodiment of the present invention, the scanning electrode is set on the surface of the array substrate, the insulation layer, the shield electrode, the passivation layer and the pixel electrode set on the scanning electrode sequentially, wherein the shield electrode is a bar-like electrode set above the scanning electrode and parallel to the data electrode, the width of the shield electrode is larger than that of the scanning electrode, the shield electrode at least extends to the edge of the adjacent two pixel electrodes located at the both sides of the scanning electrode.

According to a preferred embodiment of the present invention, the shield electrode is transparent electrode layer set parallel to the scanning electrode.

According to a preferred embodiment of the present invention, the shield electrode is opaque metal layer set parallel to the scanning electrode.

According to a preferred embodiment of the present invention, the data electrode is set on the surface of the array substrate, the insulation layer, the shield electrode, the passivation layer and the pixel electrode set on the data electrode sequentially, the shield electrode is a bar-like electrode set above the data electrode and parallel to the scanning electrode, the width of the shield electrode is larger than that of the data electrode, the shield electrode at least extends to the edge of the adjacent two pixel electrodes located at the both sides of the data electrode.

According to a preferred embodiment of the present invention, the shield electrode is transparent electrode layer set parallel to the data electrode.

According to a preferred embodiment of the present invention, the shield electrode is opaque metal layer set parallel to the data electrode.

To achieve the above technical issue, the present invention provides a liquid crystal display device, which comprises a display panel, the display panel comprises an array substrate and a color filter substrate set opposite to each other and a liquid crystal layer set in between, the array substrate has a shield electrode, the color filter substrate has a common electrode, the common electrode and the shield electrode are equipotential so that the liquid crystal layer between the common electrode and the shield electrode forms normally black display.

According to a preferred embodiment of the present invention, the array substrate comprises a data electrode and a scanning electrode set perpendicular to each other, and a pixel electrode set in the area surrounded by the data electrode and the scanning electrode, wherein the shield electrode is set below the pixel electrode.

According to a preferred embodiment of the present invention, the scanning electrode is set on the surface of the array substrate, an insulation layer, the shield electrode, a passivation layer and the pixel electrode set on the scanning electrode sequentially, the shield electrode is an entirely transparent electrode layer covered on the insulation layer.

According to a preferred embodiment of the present invention, the scanning electrode is set on the surface of the array substrate, the insulation layer, the shield electrode, the passivation layer and the pixel electrode set on the scanning electrode sequentially, wherein the shield electrode is a bar-like electrode set above the scanning electrode and parallel to the data electrode, the width of the shield electrode is larger than that of the scanning electrode, the shield electrode at least extends to the edge of the adjacent two pixel electrodes located at the both sides of the scanning electrode.

According to a preferred embodiment of the present invention, the shield electrode is transparent electrode layer or opaque metal layer set parallel to the scanning electrode.

According to a preferred embodiment of the present invention, the data electrode is set on the surface of the array substrate, the insulation layer, the shield electrode, the passivation layer and the pixel electrode set on the data electrode sequentially, the shield electrode is a bar-like electrode set above the data electrode and parallel to the scanning electrode, the width of the shield electrode is larger than that of the data electrode, the shield electrode at least extends to the edge of the adjacent two pixel electrodes located at the both sides of the data electrode.

According to a preferred embodiment of the present invention, the shield electrode is transparent electrode layer or opaque metal layer set parallel to the data electrode.

The efficacy of the present invention is that to distinguish from the state of the art, the present invention adds a shield electrode on the array substrate. The shield electrode and the common electrode on the color filter substrate are equipotential, which allows the liquid crystal layer set in between forming normally black display that substitutes BM layer to achieve the shielding effect and improves the opening ratio of the display panel.

Furthermore, because of the great reduction of the BM layer, the opening area of the display panel can effectively avoid the generation of the display differences due to the deviation of the group accuracy of the two substrates, thus making the optical performance of products more stable.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing the structure of a known display panel;

FIG. 2 is a schematic view illustrating the partial structure of a pixel region of the display panel shown in FIG. 1;

FIG. 3 is a schematic view illustrating cross-sectional structure of FIG. 2 taken along the line AA;

FIG. 4 is a schematic view illustrating the structure of first embodiment of display panel according to the present invention;

FIG. 5 is a schematic view illustrating cross-sectional structure of FIG. 4 taken along the line BB;

FIG. 6 is a schematic view illustrating the structure of second embodiment of display panel according to the present invention;

FIG. 7 is a schematic view illustrating cross-sectional structure of FIG. 6 taken along the line CC;

FIG. 8 is a schematic view illustrating the structure of third embodiment of display panel according to the present invention;

FIG. 9 is a schematic view illustrating cross-sectional structure of FIG. 8 taken along the line DD.

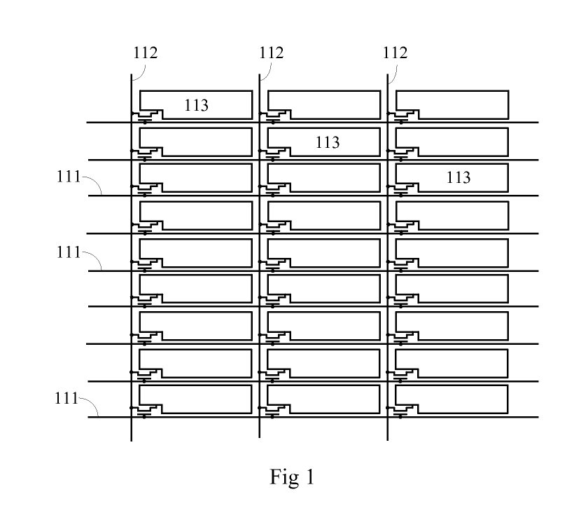

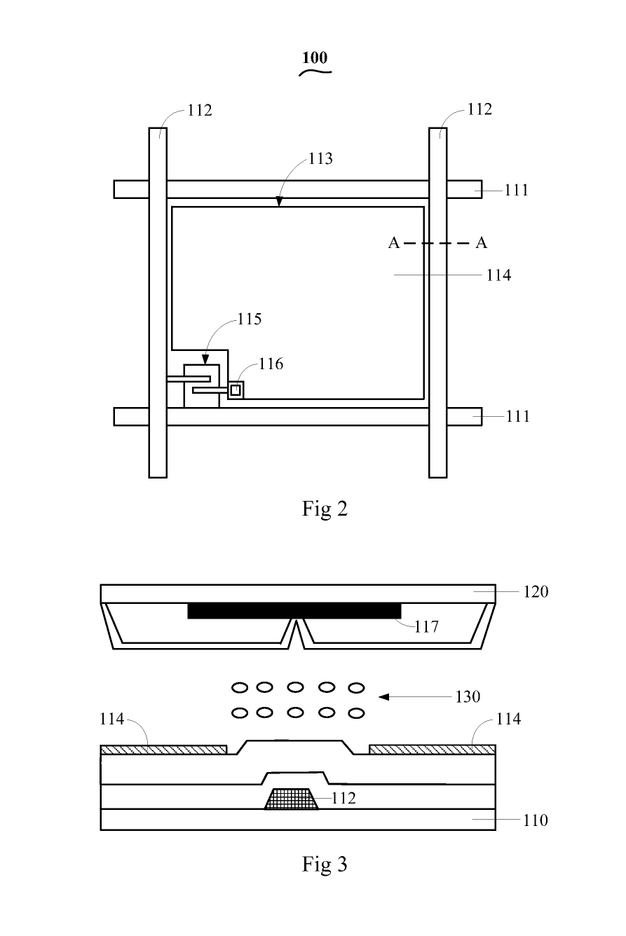

### DETAILED DESCRIPTION OF THE PREFERRED EMBODIMENTS

The detailed descriptions accompanying drawings and the embodiment of the present invention are as follows.

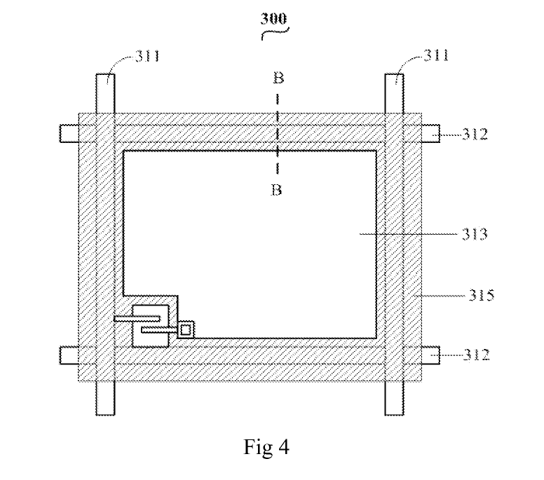

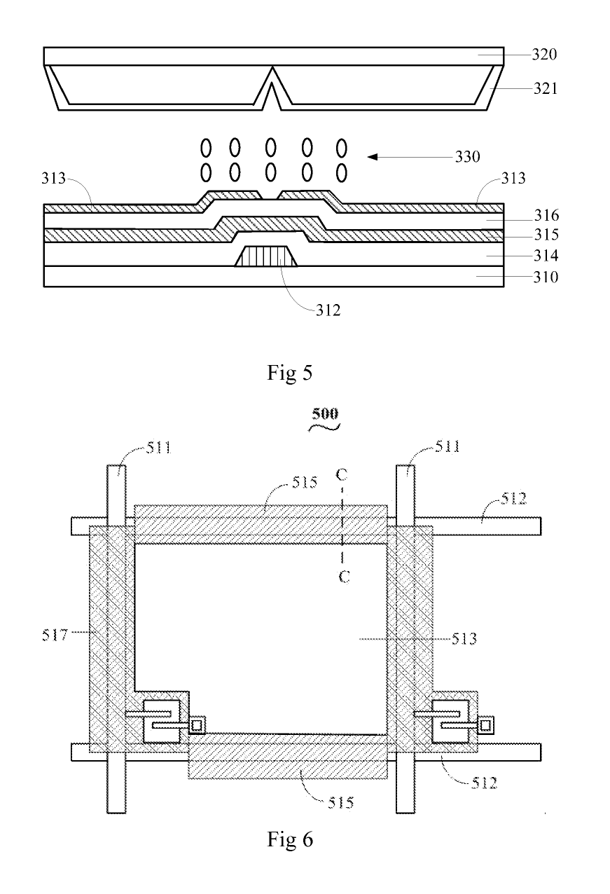

FIG. 4 is a schematic view illustrating the structure of first embodiment of display panel according to the present invention. FIG. 5 is a schematic view illustrating cross-sectional structure of FIG. 4 taken along the line BB. Referring to FIG. 4 and FIG. 5, the display panel 300 comprises an array substrate 310, a color filter substrate 320 and a liquid crystal layer 330.

Wherein the array substrate 310 and the color filter substrate 320 are set opposite to each other, and the liquid crystal layer 330 is set between the array substrate 310 and the color filter substrate 320. The color filter substrate 320 has a common electrode 321, the surface of the array substrate 310 has a plurality of data electrodes 311 set in parallel, a plurality of scanning electrodes 312 set perpendicular to the data electrodes 311, and a pixel electrode 313 set in the area surrounded by the data electrode 311 and the scanning electrode 312. As shown in FIG. 4, an insulation layer 314, the shield electrode 315, a passivation layer 316 are set on the scanning electrode 312 sequentially, and the pixel electrode 313 is set on the passivation layer 316.

In the instant embodiment, the shield electrode 315 is set below the pixel electrode 313 and is an entirely transparent electrode layer covered on the insulation layer 314.

When the display panel 300 according to the present invention is working, the shield electrode 315 can shield the electric field located below, namely, the entire rectangular region of the electric field below the shield electrode 315. The shield electrode 315 and the common electrode 321 are equipotential so that the formed electric field results the deflection of the liquid crystal molecules in the liquid crystal layer 330 set in between, and then forms normally black display. Under normally black display, the blocking light from the known black matrix layer as shown in FIG. 3 is not necessary at the region from the scanning electrode 312 and the data electrode 311 to the pixel electrode 313 on the color filter substrate 320 of the display panel 300, which increases the opening ratio obviously.

It is noted that the materials of the shield electrode 315 and the common electrode 321 according to the instant embodiment are the same, which is transparent electrode layer such as indium tin oxide (ITO).

It is noted that the array substrate 310 and the color filter substrate 320 does not have to group very precisely in the cell process of the display panel 300 due to the cancel of the black matrix layer. Even if a certain degree of deviation comes out under grouping, the deviation area of the liquid crystal layer 330 will not form the normally black display without the effects of the equipotential electric field, which makes the optical performance of the display panel 300 more stable.

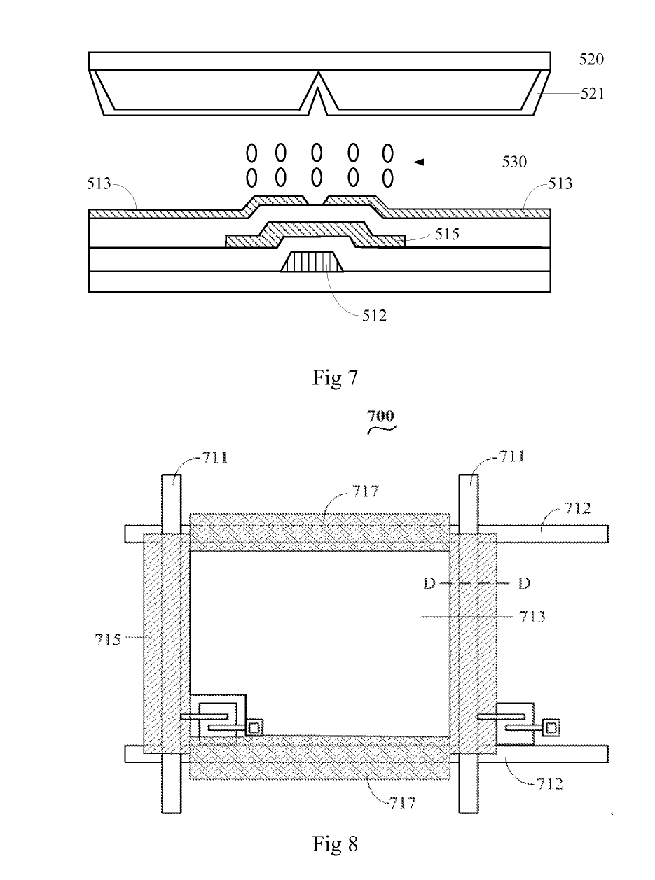

FIG. 6 is a schematic view illustrating the structure of second embodiment of display panel according to the present invention, and FIG. 7 is a schematic view illustrating cross-sectional structure of FIG. 6 taken along the line CC. Referring to FIG. 6 and FIG. 7, the main difference between the display panel 500 and the display panel 300 according to the first embodiment is: in the instant embodiment, the shield electrode 515 is a bar-like electrode set above the scanning electrode 512.

Wherein, in the direction parallel to the data electrode 511, namely, the cross-section taken along the line CC as shown in FIG. 7, the width of the shield electrode 515 is larger than that of the scanning electrode 512. The shield electrode 515 at least extends to the edge of the adjacent two pixel electrodes 513 located at the both sides of the scanning electrode 512.

Moreover, there is a black matrix layer 517 set above the data electrode 511 of the display panel 500. The width of the black matrix layer 517 is larger than that of the data electrode 511. The black matrix layer 517 at least extends to the edge of the adjacent two pixel electrodes 513 located at the both sides of the data electrode 511.

When the display panel 500 according to the instant embodiment is working, the shield electrode 515 can shield the electric field located below, namely, the electric field happened at all scanning electrode 512 and the edges from the scanning electrode 512 to the pixel electrode 513 below the shield electrode 515. The shield electrode 515 and the common electrode 521 are equipotential so that the formed electric field results the deflection of the liquid crystal molecules in the liquid crystal layer 530 set in between, and then forms normally black display. Under the normally black display, the blocking light from the known black matrix layer as shown in FIG. 3 is not necessary at the region from the scanning electrode 512 and the scanning electrode 512 to the pixel electrode 513 on the color filter substrate 520 of the display panel 500, which increases the opening ratio obviously.

It is noted that the main role of the shield electrode 515 is making the covered area opaque. Therefore, the materials of the shield electrode 515 and the common electrode 521 according to the instant embodiment are the same, which is transparent electrode layer such as indium tin oxide (ITO) or opaque metal layer such as copper and aluminum.

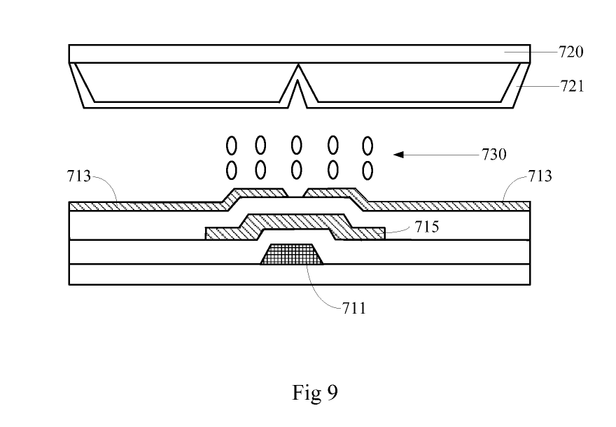

FIG. 8 is a schematic view illustrating the structure of third embodiment of display panel according to the present invention, and FIG. 9 is a schematic view illustrating cross-sectional structure of FIG. 8 taken along the line DD. Referring to FIG. 8 and FIG. 9, the main difference between the display panel 700 and the display panel 300 and 500 according to the first and second embodiment is: in the instant embodiment, the shield electrode 715 is a bar-like electrode set above the data electrode 711.

Wherein, in the direction parallel to the scanning electrode 712, namely, the cross-section taken along the line DD as shown in FIG. 9, the width of the shield electrode 715 is larger than that of the data electrode 711. The shield electrode 715 at least extends to the edge of the adjacent two pixel electrodes 713 located at the both sides of the data electrode 711.

Moreover, there is a black matrix layer 717 set above the scanning electrode 712 of the display panel 700. The width of the black matrix layer 717 is larger than that of the scanning electrode 712. The black matrix layer 717 at least extends to the edge of the adjacent two pixel electrodes 713 located at the both sides of the scanning electrode 712.

When the display panel 700 according to the instant embodiment is working, the shield electrode 715 can shield the electric field located below, namely, the electric field happened at all data electrode 711 and the edges from the data electrode 711 to the pixel electrode 713 below the shield electrode 715. The shield electrode 715 and the common electrode 721 are equipotential so that the formed electric field results the deflection of the liquid crystal molecules in the liquid crystal layer 730 set in between, and then forms normally black display. Under the normally black display, the blocking light from the known black matrix layer as shown in FIG. 3 is not necessary at the region from the data electrode 711 and the data electrode 711 to the pixel electrode 713 on the color filter substrate 720 of the display panel 700, which increases the opening ratio obviously.

It is noted that the main role of the shield electrode 715 is making the covered area opaque. Therefore, the materials of the shield electrode 715 and the common electrode 721 according to the instant embodiment are the same, which is transparent electrode layer such as indium tin oxide (ITO) or opaque metal layer such as copper and aluminum.

The present invention also provides a liquid crystal display device. The liquid crystal display device according to the present invention comprises the display panel 300, 500 or 700 corresponding to the said embodiment. The specific structure and display principle of the liquid crystal display device according to the present invention can refer to existing technologies and not be repeated here.

In summary, the present invention adds a shield electrode on the array substrate. The shield electrode and the common electrode on the color filter substrate are equipotential, which allows the liquid crystal layer set in between forming normally black display that substitutes BM layer to achieve the shielding effect and improves the opening ratio of the display panel.

Moreover, because of the great reduction of the BM layer, the opening area of the display panel can effectively avoid the generation of the display differences due to the deviation of the group accuracy of the two substrates, thus making the optical performance of products more stable.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A display panel, wherein the display panel comprises an array substrate and a color filter substrate set opposite to each other and a liquid crystal layer set in between, wherein:
the array substrate having a shield electrode, the color filter substrate having a common electrode, the common electrode and the shield electrode being equipotential so that the liquid crystal layer between the common electrode and the shield electrode forms normally black display; wherein the array substrate further comprises a data electrode and a scanning electrode set perpendicular to each other, and a pixel electrode set in the area surrounded by the data electrode and the scanning electrode, the shield electrode set below the pixel electrode, and the shield electrode being transparent electrode layer or opaque metal layer set parallel to the scanning electrode.

2. The display panel as claimed in claim 1, wherein the scanning electrode is set on the surface of the array substrate, an insulation layer, the shield electrode, a passivation layer and the pixel electrode set on the scanning electrode sequentially, wherein the shield electrode is an entirely transparent electrode layer covered on the insulation layer.

3. The display panel as claimed in claim 1, wherein the scanning electrode is set on the surface of the array substrate, the insulation layer, the shield electrode, the passivation layer and the pixel electrode set on the scanning electrode sequentially, wherein the shield electrode is a bar-like electrode set above the scanning electrode and parallel to the data electrode, the width of the shield electrode is larger than that of the scanning electrode, the shield electrode at least extends to the edge of the adjacent two pixel electrodes located at the both sides of the scanning electrode.

4. The display panel as claimed in claim 1, wherein the data electrode is set on the surface of the array substrate, the insulation layer, the shield electrode, the passivation layer and the pixel electrode set on the data electrode sequentially, wherein the shield electrode is a bar-like electrode set above the data electrode and parallel to the scanning electrode, the width of the shield electrode is larger than that of the data electrode, the shield electrode at least extends to the edge of the adjacent two pixel electrodes located at the both sides of the data electrode.

5. A display panel, wherein the display panel comprises an array substrate and a color filter substrate set opposite to each other and a liquid crystal layer set in between, wherein:
the array substrate having a shield electrode, the color filter substrate having a common electrode, the common electrode and the shield electrode being equipotential so that the liquid crystal layer between the common electrode and the shield electrode forms normally black display.

6. The display panel as claimed in claim 5, wherein the array substrate comprises a data electrode and a scanning electrode set perpendicular to each other, and a pixel electrode set in the area surrounded by the data electrode and the scanning electrode, wherein the shield electrode is set below the pixel electrode.

7. The display panel as claimed in claim 6, wherein the scanning electrode is set on the surface of the array substrate, an insulation layer, the shield electrode, a passivation layer and the pixel electrode set on the scanning electrode sequentially, wherein the shield electrode is an entirely transparent electrode layer covered on the insulation layer.

8. The display panel as claimed in claim 6, wherein the scanning electrode is set on the surface of the array substrate, the insulation layer, the shield electrode, the passivation layer and the pixel electrode set on the scanning electrode sequentially, wherein the shield electrode is a bar-like electrode set above the scanning electrode and parallel to the data electrode, the width of the shield electrode is larger than that of the scanning electrode, the shield electrode at least extends to the edge of the adjacent two pixel electrodes located at the both sides of the scanning electrode.

9. The display panel as claimed in claim 8, wherein the shield electrode is transparent electrode layer set parallel to the scanning electrode.

10. The display panel as claimed in claim 8, wherein the shield electrode is opaque metal layer set parallel to the scanning electrode.

11. The display panel as claimed in claim 6, wherein the data electrode is set on the surface of the array substrate, the insulation layer, the shield electrode, the passivation layer and the pixel electrode set on the data electrode sequentially, wherein the shield electrode is a bar-like electrode set above the data electrode and parallel to the scanning electrode, the width of the shield electrode is larger than that of the data electrode, the shield electrode at least extends to the edge of the adjacent two pixel electrodes located at the both sides of the data electrode.

12. The display panel as claimed in claim 11, wherein the shield electrode is transparent electrode layer set parallel to the data electrode.

13. The display panel as claimed in claim 11, wherein the shield electrode is opaque metal layer set parallel to the data electrode.

14. A liquid crystal display device, wherein the crystal liquid crystal device comprises a display panel, the display panel comprises an array substrate and a color filter substrate set opposite to each other and a liquid crystal layer set in between, wherein:
the array substrate having a shield electrode, the color filter substrate having a common electrode, the common electrode and the shield electrode being equipotential so that the liquid crystal layer between the common electrode and the shield electrode forms normally black display.

15. The liquid crystal display device as claimed in claim 14, wherein the array substrate comprises a data electrode and a scanning electrode set perpendicular to each other, and a pixel electrode set in the area surrounded by the data electrode and the scanning electrode, wherein the shield electrode is set below the pixel electrode.

16. The liquid crystal display device as claimed in claim 15, wherein the scanning electrode is set on the surface of the array substrate, an insulation layer, the shield electrode, a passivation layer and the pixel electrode set on the scanning electrode sequentially, wherein the shield electrode is an entirely transparent electrode layer covered on the insulation layer.

17. The liquid crystal display device as claimed in claim 15, wherein the scanning electrode is set on the surface of the array substrate, the insulation layer, the shield electrode, the passivation layer and the pixel electrode set on the scanning electrode sequentially, wherein the shield electrode is a bar-like electrode set above the scanning electrode and parallel to the data electrode, the width of the shield electrode is larger than that of the scanning electrode, the shield electrode at least extends to the edge of the adjacent two pixel electrodes located at the both sides of the scanning electrode.

18. The liquid crystal display device as claimed in claim 17, wherein the shield electrode is transparent electrode layer or opaque metal layer set parallel to the scanning electrode.

19. The liquid crystal display device as claimed in claim 15, wherein the data electrode is set on the surface of the array substrate, the insulation layer, the shield electrode, the passivation layer and the pixel electrode set on the data electrode sequentially, wherein the shield electrode is a bar-like electrode set above the data electrode and parallel to the scanning electrode, the width of the shield electrode is larger than that of the data electrode, the shield electrode at least extends to the edge of the adjacent two pixel electrodes located at the both sides of the data electrode.

20. The liquid crystal display device as claimed in claim 19, wherein the shield electrode is transparent electrode layer or opaque metal layer set parallel to the data electrode.
